(19) United States
(12) Patent Application Publication
(10) Pub. No.: US 2026/0317570 A1
(43) Pub. Date: Oct. 15, 2026

(54) METHOD FOR PRODUCING CONDUCTIVE BASE MATERIAL, METHOD FOR PRODUCING ELECTRONIC DEVICE, METHOD FOR PRODUCING ELECTROMAGNETIC SHIELD FILM, METHOD FOR PRODUCING SHEET-LIKE HEATING ELEMENT, AND CONDUCTIVE COMPOSITION

(71) Applicant: SATO HOLDINGS KABUSHIKI KAISHA, Tokyo (JP)

(72) Inventors: Takayuki OGAWA, Minato-ku, Tokyo (JP); Takeshi SHIBATA, Minato-ku, Tokyo (JP)

(73) Assignee: SATO HOLDINGS KABUSHIKI KAISHA, Tokyo (JP)

(21) Appl. No.: 19/101,102

(22) PCT Filed: Sep. 11, 2023
(86) PCT No.: PCT/JP2023/033030

§ 371 Date: Feb. 4, 2025

(30) Foreign Application Priority Data
Sep. 16, 2022 (JP) 2022-148049

(51) Int. Cl. C09D 11/52; C09D 11/037; C23C 24/10

(52) U.S. Cl. CPC C09D 11/52; C09D 11/037; C23C 24/106

(57) ABSTRACT

A method for producing a conductive base material includes a coating step of coating a conductive composition that contains conductive particles on a base material to provide a coating layer, and a conductive film formation step of forming a conductive film by at least pressing the coating layer. In a volume-based cumulative particle size distribution curve obtained by particle size measurement of the conductive particles using a laser diffraction-scattering method, in a case where D₅₀ is a particle size at which a cumulative frequency reaches 50%, D₁₀ is a particle size at which the cumulative frequency reaches 10%, and Do is a particle size at which the cumulative frequency reaches 90%, (a) and (b) are satisfied. (a) D₅₀ is 0.6 to 50 μm. (b) (D₉₀−D₅₀)/D₅₀ is 0.55 to 3.0.

### TECHNICAL FIELD

The present invention relates to a method for producing a conductive base material, a method for producing an electronic device, a method for producing an electromagnetic shield film, a method for producing a sheet-like heating element, and a conductive composition.

### BACKGROUND ART

A technique is known in which a conductive base material provided with a conductive film is formed by coating a conductive composition containing conductive particles on a base material to provide a coating layer and then carrying out heating, pressing, and the like on the coating layer.

As an example, the Examples of Patent Document 1 describe coating a dispersion of silver fine particles having an average primary particle size of 7 nm in water/ethylene glycol on a PET film to form a coating film and then heating and pressing the coating film at 150° C., as well as forming a conductive layer by means of this step.

As another example, the Examples of Patent Document 2 describe spin-coating a copper fine particle dispersion liquid (copper nano-ink) having copper fine particles (copper nano-particles) having a median diameter of approximately 40 nm, a dispersion medium, and a dispersant on a glass base material to form a coating film and then baking the coating film to form a conductive film.

As a further example, Patent Document 3 describes coating a conductive ink composition containing (A) an oxycarboxylic acid, (B) a nitrogen-containing compound, (C) copper particles, and (D) a dispersion medium on a base material to form a coating film and then treating the coating film to form a conductive layer.

### RELATED DOCUMENT

### Patent Document

Patent Document 1: Japanese Patent Application No. 6181608
Patent Document 2: Japanese Unexamined Patent Application, First Publication No. 2021-044308
Patent Document 3: Japanese Unexamined Patent Application, First Publication No. 2017-191723

### SUMMARY OF THE INVENTION

### Technical Problem

When forming a conductive film using a conductive composition containing conductive particles, the resistivity of the conductive film is preferably as small as possible. In addition, being able to produce a conductive film having a low resistivity by a simple and not overly complicated process is more preferable.

The present invention was made in consideration of these circumstances. One of the objects of the present invention is to provide a method for producing a conductive base material capable of forming a conductive film having a low resistivity.

### Solution to Problem

The present inventors completed the inventions provided below and solved the above-described problems.

1.

A method for producing a conductive base material, the method including
a coating step of coating a conductive composition that contains conductive particles on a base material to provide a coating layer, and
a conductive film formation step of forming a conductive film by at least pressing the coating layer,
in which the conductive particles satisfy the following conditions.

### (Conditions)

In a volume-based cumulative particle size distribution curve obtained by particle size measurement of the conductive particles using a laser diffraction-scattering method, in a case where D₅₀ is a particle size at which a cumulative frequency reaches 50%, D₁₀ is a particle size at which the cumulative frequency reaches 108, and Doo is a particle size at which the cumulative frequency reaches 90%, (a) and (b) are satisfied.
(a) D₅₀ is 0.6 to 50 μm.
(b) (D₉₀−D₅₀)/D₅₀ is 0.55 to 3.0.

2.

The method for producing a conductive base material according to 1.,
in which the base material is flexible.

3.

The method for producing a conductive base material according to 1, or 2.,
in which, in the conductive film formation step, the coating layer is pressed while being heated.

4.

The method for producing a conductive base material according to any one of 1. to 3.,
in which (c) is also satisfied.
(c) (D₅₀−D₁₀)/D₅₀ is 0.4 to 0.8.

5.

The method for producing a conductive base material according to any one of 1. to 4., in which, in the volume-based cumulative particle size distribution curve obtained by the particle size measurement of the conductive particles using the laser diffraction-scattering method, in a case where D₉₅ is a particle size at which the cumulative frequency reaches 95%, D₉₅ is 1.5 to 100 μm.

6.

The method for producing a conductive base material according to any one of 1. to 5., in which an amount of binder in all non-volatile components of the conductive composition is 5% by mass or less.

7.

The method for producing a conductive base material according to any one of 1. to 6.,
in which the base material is at least one selected from the group consisting of polyester, polyolefin, polyimide, and paper.

8.

The method for producing a conductive base material according to any one of 1. to 7.,
in which the conductive film formation step includes a roll press step of transporting the base material provided with the coating layer between two opposing rolls.

9.

The method for producing a conductive base material according to 8,
in which, in the roll press step, a roll of the two rolls with which the coating layer comes into contact is not heated, or is heated to 400° C. or lower.

10.

The method for producing a conductive base material according to 8, or 9.,
in which, in the roll press step, a pressure of 10 MPa or more is applied to the base material provided with the coating layer.

11.

The method for producing a conductive base material according to any one of 1. to 7.,
in which the conductive film formation step includes a step of placing the base material provided with the coating layer on a flat plate or on a flat surface of a table having the flat surface, and at least pressing the coating layer from above using a roll.

12.

The method for producing a conductive base material according to any one of 1. to 7.,
in which the conductive film formation step includes a step of sandwiching the base material provided with the coating layer between a first flat surface of a first pressing member having the first flat surface and a second flat surface of a second pressing member having the second flat surface.

13.

The method for producing a conductive base material according to any one of 1. to 12.,
in which the conductive film has a pattern structure.

14.

A method for producing an electronic device,
in which the electronic device is produced using the conductive base material obtained by the method for producing a conductive base material according to any one of 1. to 13.

15.

The method for producing an electronic device according to 14.,
in which the electronic device is an RF tag.

16.

A method for producing an electromagnetic shield film, in which the electromagnetic shield film is produced using the conductive base material obtained by the method for producing a conductive base material according to any one of 1. to 13.

17.

A method for producing a sheet-like heating element, in which the sheet-like heating element is produced using the conductive base material obtained by the method for producing a conductive base material according to any one of 1. to 13.

18.

A conductive composition containing conductive particles, which is used for applications in which a coating layer is formed by coating the conductive composition on a base material and the coating layer is at least pressed to form a conductive film,
in which the conductive particles satisfy the following conditions.

### (Conditions)

In a volume-based cumulative particle size distribution curve obtained by particle size measurement of the conductive particles using a laser diffraction-scattering method, in a case where D₅₀ is a particle size at which a cumulative frequency reaches 50%, D₁₀ is a particle size at which the cumulative frequency reaches 108, and Doo is a particle size at which the cumulative frequency reaches 90%, (a) and (b) are satisfied.
(a) D₅₀ is 0.6 to 50 μm.
(b) (D₉₀−D₅₀)/D₅₀ is 0.55 to 3.0.

19.

The conductive composition according to 18.,
in which the conductive particles also satisfy (c).
(c) (D₅₀−D₁₀)/D₅₀ is 0.4 to 0.8.

20.

The conductive composition according to 18, or 19., in which, in the volume-based cumulative particle size distribution curve obtained by the particle size measurement of the conductive particles using the laser diffraction-scattering method, in a case where Dos is a particle size at which the cumulative frequency reaches 958, D₉₅ is 1.5 to 100 μm.

21.

The conductive composition according to any one of 18. to 20.,
in which an amount of binder in all non-volatile components is 5% by mass or less.

### Advantageous Effects of Invention

According to the present invention, it is possible to form a conductive film having a low resistivity.

### BRIEF DESCRIPTION OF THE DRAWINGS

FIG. 1 A diagram for illustrating a coating step.

FIG. 2 A diagram for illustrating a conductive film formation step.

FIG. 3 A diagram for illustrating the conductive film formation step.

FIG. 4 A diagram for illustrating the conductive film formation step.

FIG. 5 A diagram for showing a specific form of a roughening treatment in a screen mesh used in the Examples.

### DESCRIPTION OF EMBODIMENTS

A detailed explanation will be given below of an embodiment of the present invention with reference to the drawings.

In all the drawings, the same components are given the same reference numerals and explanations thereof will not be repeated as appropriate.

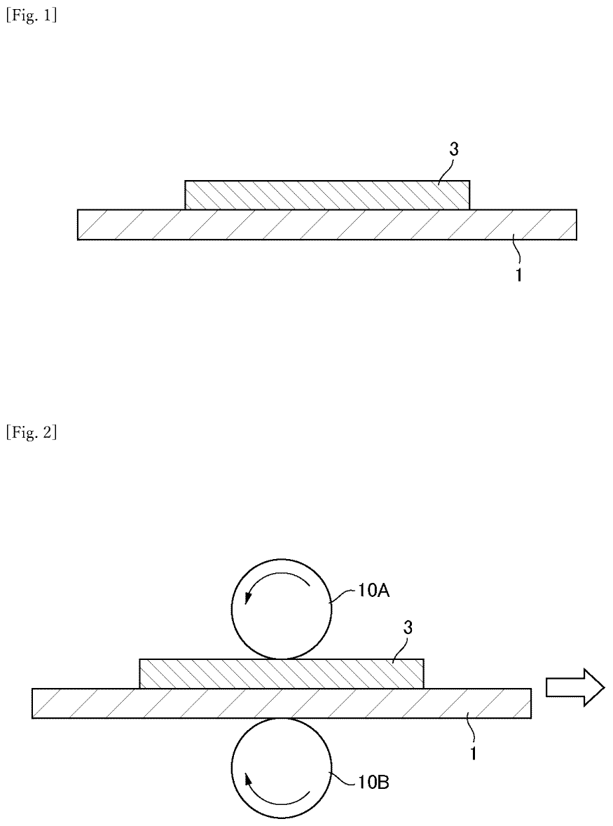

To avoid complexity, (i) when there are a plurality of identical components in the same drawing, a reference numeral may be assigned to only one thereof, and not all thereof, or (ii) particularly in FIG. 2 and subsequent figures, reference numerals may not be reassigned to the same components as in FIG. 1.

All the drawings are for illustration purposes only. The shapes, dimensional ratios, and the like of each of the members in the drawings do not necessarily correspond to the actual products.

In the present specification, the notation “X to Y” in the explanation of the range of values means equal to or more than X and equal to or less than Y, unless otherwise specified. For example, “1 to 5% by mass” means “equal to or more than 1% by mass and equal to or less than 5% by mass”.

### <Method for Producing Conductive Base Material>

The method for producing a conductive base material in the present embodiment includes a coating step of coating a conductive composition that contains conductive particles on a base material to provide a coating layer, and a conductive film formation step of forming a conductive film by at least pressing the coating layer.

A specific explanation will be given below of each step with reference to the drawings.

### (FIG. 1: Coating Step)

In the coating step, a conductive composition containing conductive particles is coated on a base material 1 (the surface of at least one side of the base material 1) to provide a coating layer 3.

At this time, the conductive particles included in the conductive composition satisfy the following conditions.

### (Conditions)

In a volume-based cumulative particle size distribution curve obtained by particle size measurement of the conductive particles using a laser diffraction-scattering method, when D₅₀ is the particle size at which a cumulative frequency reaches 50%, D₁₀ is the particle size at which the cumulative frequency reaches 10%, and D₉₀ is the particle size at which the cumulative frequency reaches 90%, (a) and (b) described below are satisfied.
(a) D₅₀ is 0.6 to 50 μm.
(b) (D₉₀−D₅₀)/D₅₀ is 0.55 to 3.0.

As described below, the coating layer 3 becomes a conductive film by being at least pressed. When the conductive particles included in the conductive composition satisfy the above (Conditions), it is possible to reduce the resistivity of the conductive film. It is possible to explain the reason as follows. To be clear, the following explanation includes speculation and the present invention is not to be interpreted in a limited manner by the following explanation.

In the related art techniques for forming a conductive base material provided with a conductive film by coating a conductive composition containing conductive particles on a base material to provide a coating layer and then carrying out heating, pressing, and the like on the coating layer, nano-sized conductive particles were often used. This is because there is a sintering promotion effect when the size of the conductive particles is approximately 100 nm or less. Specifically, when the size of the conductive particles is approximately 100 nm or less, the free energy of the entire system increases due to an increase in surface area and the conductive particles tend to sinter together to reduce the free energy. The above is explainable based on theories of physical chemistry.

However, when nano-sized metal particles are used, the number of particle boundaries between the conductive particles per unit volume tends to be extremely large. The presence of particle boundaries causes resistance to increase.

Therefore, the present inventors decided to use conductive particles having sub-micron to micron order diameters, rather than nano-sized conductive particles. Specifically, in a volume-based cumulative particle size distribution curve obtained by particle size measurement using a laser diffraction-scattering method, conductive particles having a particle size D₅₀, at which the cumulative frequency is 50%, of 0.6 to 50 μm were used. Incidentally, conductive particles having sub-micron to micron order diameters also have the advantage of being cheaper and easier to obtain than nano-sized particles.

However, when the ratio of coarse particles in the conductive particles is high, even when D₅₀ is 0.6 to 50 μm, “gaps” are likely to occur between the conductive particles and there is a concern that the resistance of the conductive film will increase as a result. Therefore, in the present embodiment, not only D₅₀, but also the value of (D₉₀−D₅₀)/D₅₀, which may be said to be the “relative” Do size based on D₅₀, is set to 3.0 or less.

Incidentally, 0.6, which is the lower limit value of (D₉₀-D₅₀)/D₅₀, is set in consideration of the particle size distribution of conductive particles that are easily available industrially.

A more specific explanation will be given below of the coating step.

### Particle Size Distribution of Conductive Particles

As described above, for the conductive particles, D₅₀ may be 0.6 to 50 μm and (D₉₀−D₅₀)/D₅₀ may be 0.55 to 3.0.
D₅₀ is preferably 0.6 to 30 μm, more preferably 0.7 to 20 μm, and even more preferably 0.7 to 15 μm.
(D₉₀−D₅₀)/D₅₀ is preferably 0.55 to 2.5 and more preferably 0.55 to 2.

It is preferable that the conductive particles also satisfy (c).
(c) (D₅₀−D₁₀)/D₅₀ is 0.4 to 0.8, more preferably 0.4 to 0.7, and even more preferably 0.5 to 0.7.

To improve the conductivity of the conductive film obtained by at least pressing a coating film including conductive particles, it is preferable to increase the density of the conductive particles in the coating film. It is considered that a method for this purpose is to adjust and optimize the particle size distribution of the conductive particles such that an appropriate amount of particles having relatively small particle sizes are present in the “gaps” between particles having relatively large particle sizes. It is possible to interpret the above-described (c) as corresponding to the presence of an appropriate amount of particles having relatively small particle sizes in the conductive particles, compared to particles with particle sizes near the median value D₅₀.

In addition, it is also considered that the inclusion of a “certain amount” of sub-micron-sized conductive particles has a certain sintering promotion effect.

From another viewpoint, in a volume-based cumulative particle size distribution curve obtained by particle size measurement of the conductive particles using a laser diffraction-scattering method, when D₉₅ is a particle size at which the cumulative frequency reaches 958, D₉₅ is preferably 1.5 to 100 μm, more preferably 1.5 to 50 μm, and even more preferably 1.5 to 30 μm.

As described above, when the ratio of coarse particles in the conductive particles is large, even when D₅₀ is 0.6 to 50 μm, there is a concern that “gaps” will easily occur between the conductive particles and that the resistance of the conductive film will increase as a result. For this reason, in the present embodiment, it is essential that the value of (D₉₀−D₅₀)/D₅₀ is 3.0 or less and, in addition, it is considered that by having a D₉₅ value that is not excessively large, “gaps” will be less likely to occur between the conductive particles, resulting in the resistivity of the obtained conductive film becoming smaller.

For the values of D₅₀ and the like for certain conductive particles, when the conductive particles are purchased and the volume-based cumulative particle size distribution curve of the conductive particles is provided by the supplier, it is possible to obtain the values of D₅₀ and the like based on the curve. When the values of D₅₀ and the like are provided by the supplier, it is possible to adopt the provided values.

Meanwhile, when it is not possible to obtain the values of D₅₀ and the like as described above, the conductive particles are measured for particle size by the laser diffraction-scattering method to obtain the volume-based cumulative particle size distribution curve. Measurements are usually performed using a wet method. In this case, examples of the dispersion medium include water or isopropanol including a surfactant (the appropriate dispersion medium is selected taking into account the state of the surface treatment agent of the conductive particles, and the like). Examples of measuring devices include the SALD series (SALD-2300 or the like) from Shimadzu Corporation. When using the SALD series as a device, it is preferable to measure the particle size while circulating the dispersion medium while generating ultrasonic waves using the attached ultrasonic unit.

### Chemical Composition of Conductive Particles

From the viewpoint of easy availability and good conductivity, the conductive particles preferably include at least one element selected from the group consisting of silver and copper.

Specifically, the conductive particles preferably include at least one selected from the group consisting of particles mainly composed of silver and particles mainly composed of copper. Here, the expression “mainly composed of silver” means that the ratio of the silver element to all constituent elements in the particles is preferably 50 mol % or more, more preferably 75 mol % or more, even more preferably 90 mol % or more, and particularly preferably 95 mol % or more. Similarly, the expression “mainly composed of copper” means that the ratio of the copper element to all constituent elements in the particles is preferably 50 mol % or more, more preferably 75 mol % or more, even more preferably 90 mol % or more, and particularly preferably 95 mol % or more.

To be clear, the conductive particles may include elements other than silver and copper as long as the desired conductivity is obtained. Examples of elements other than silver and copper include gold, aluminum, platinum, palladium, iridium, tungsten, nickel, tantalum, lead, zinc, and the like.

The conductive particles may include two or more elements. For example, conductive particles in which the surface of copper particles is silver-plated (silver-coated copper particles) and the like are preferably used in the present embodiment. Silver-coated copper particles are particles mainly composed of copper for which the surface of the copper particles is plated with silver in an amount of up to a maximum of 35% by mass based on the total mass of the particles, for example.

### Method for Obtaining Conductive Particles

It is possible to purchase conductive particles that are usable in the present embodiment from, for example, Dowa Electronics Materials Co., Ltd., Fukuda Metal Foil and Powder Co., Ltd., and the like.

Incidentally, to adjust and optimize the values of (a), (b), (c), and the like, two or more different conductive particles may be mixed and used.

### Ratio of Conductive Particles in Conductive Composition

From the viewpoint of further reducing the resistivity of the conductive film, the ratio of conductive particles in the conductive composition is preferably large. Specifically, the ratio of the conductive particles in all non-volatile components of the conductive composition is preferably 95% by mass or more, more preferably 97% by mass or more, even more preferably 98% by mass or more, and particularly preferably 99% by mass or more.

Components able to be included in Conductive Composition other than Conductive Particles

The conductive composition used in the coating step contains at least conductive particles that satisfy the specific particle size distribution described above, but may include components other than such conductive particles.

It is possible for the conductive composition to include a solvent. When the conductive composition includes a solvent, the coating property of the conductive composition to the base material is improved. The solvent typically includes an organic solvent.

The type of solvent is not particularly limited. The solvent may be any solvent that does not substantially alter each of the components in the conductive composition.

The usage amount of the solvent may be adjusted appropriately depending on the conductive composition coating method, and the like. The usage amount of the solvent is, for example, 3 to 30% by mass in the entire conductive composition, preferably 5 to 25% by mass, and more preferably 10 to 20% by mass.

From the viewpoint of the adhesion to the base material 1, the coating property, the printability, and the like, the conductive composition may or may not include a binder.

When a binder is used, the type of binder is not particularly limited, but preferable examples thereof include polyvinylpyrrolidone, polyester, epoxy resin, (meth)acrylic resin, polyvinyl acetal, cellulose resin (for example, ethyl cellulose, and the like), phenol resin, and the like.

From the viewpoint of particularly increasing the conductivity of the conductive film, the amount of binder in all non-volatile components of the conductive composition is preferably 5% by mass or less, more preferably 3% by mass or less, even more preferably 2% by mass or less, and particularly preferably 18 by mass or less. The lower limit of the amount of binder may be 0. However, when it is intended to actively obtain effects such as improved adhesion by using a binder, the amount of binder is preferably 18 by mass or more in all non-volatile components of the conductive composition and more preferably 2% by mass or more. That is, from the viewpoint of the balance of various performances, the amount of the binder is preferably 1 to 5% by mass in all non-volatile components of the conductive composition and more preferably 2 to 5% by mass.

The conductive composition may or may not include various other additive components in ink compositions and conductive pastes in the related art.

### Base Material 1

The base material 1 is usually in the form of a film, sheet, or plate. From the viewpoint of industrial productivity, the shape of the base material 1 is preferably one of the above. The base material 1 is preferably flexible. By adopting the base material 1 having flexibility, it is possible to produce a flexible printed circuit board (FPC).

In addition, the base material 1 having flexibility has the advantage that the conductive film is easily formed by the roll press step in the conductive film formation step described below.

To be clear, the base material 1 may be a rigid base material that does not have flexibility.

In consideration of cost and the final use, the base material 1 is preferably at least one selected from the group consisting of polyesters such as polyethylene terephthalate (PET) and polyethylene naphthalate (PEN), polyolefins such as polyethylene and polypropylene, polyimide, and paper. Here, the paper may be coated paper (paper for which the surface is coated with a coating agent) or ordinary paper that is not coated paper. In addition, the base material 1 is not limited to PET or the like and it is possible to adopt a general resin film.

As described below, in the present embodiment, it is possible to obtain a conductive film having a sufficiently low resistivity without heating or by heating at a relatively low temperature in the conductive film formation step. Therefore, it is also possible to suitably use the base material 1 having low heat resistance such as polyester, polyolefin, and paper, as the base material. In addition, when the base material 1 having high heat resistance such as polyimide is used, it is possible to further reduce the resistivity by performing high-temperature heating in the conductive film formation step.

### Coating Method

The conductive composition coating method is not particularly limited.

The conductive composition may be coated on the entirety of one surface of the base material, or only on a part of one surface of the base material. In the former case, it is possible to perform the coating using a device such as a blade coater, an air knife coater, a doctor coater, a roll coater, a bar coater (rod coater), or a curtain coater. In the latter case, it is possible to apply various printing methods, for example, screen-printing methods, gravure printing methods, letterpress printing methods, lithographic printing methods (offset printing methods), ink jet printing methods, and the like. By appropriately designing the “pattern” of the coating, it is possible to produce a base material provided with a pattern structure, such as a conductive film (circuit pattern) able to function as a circuit or a mesh pattern that has an electromagnetic shielding ability. When the conductive composition is coated only on a part of one surface of the base material, the “pattern” of the coating is preferably appropriately designed according to the use of the finally obtained conductive film.

To prevent the conductive composition from being coated on places other than the desired places, for example, a step may be performed in which a film with holes cut out is placed on the base material 1, the conductive composition is coated from above, and then the film is removed.

A supplementary explanation will be given regarding a case where the screen-printing method is adopted as the coating method.

When the screen-printing method is adopted, it is possible for the material of the screen mesh to be synthetic fibers such as polyester or metal fibers such as stainless steel. From the viewpoint of durability and compatibility with conductive particles, and the like, the material of the screen mesh is preferably a metal fiber such as stainless steel.

When adopting the screen-printing method, it is possible to obtain advantages by using an appropriate screen mesh. Examples of the advantages include suppression of bleeding when coating is performed continuously using the screen-printing method, reduction of the surface roughness of the coating layer 3, and the like.

As an example, the screen mesh is preferably subjected to a roughening treatment. It is considered that this improves the fitting of the solvent components in the conductive composition with the screen mesh and reduces the frictional force when the conductive composition passes through the screen mesh. Even when performing continuous screen printing, it is possible to expect that the coating amount will be stabilized, the unevenness of the pattern surface will be reduced, and the like. The roughening treatment is preferably carried out on a screen mesh made of metal fibers such as stainless steel.

As another example, the screen mesh is preferably subjected to a liquid-repelling treatment. Specifically, it is preferable to use a screen mesh where a material that reduces the surface free energy, such as a fluorine-containing material (such as a fluorine resin) or a silicon-containing material (a silicone-based material), is attached to the surface. Using such a screen mesh makes it possible to suppress bleeding during pattern formation. In other words, fine patterns are more easily formed. In addition, it is possible to expect a reduction in the unevenness of the pattern surface.

Materials for carrying out a liquid-repelling treatment in screen printing are sold by, for example, Murakami Co., Ltd., Sonocom Co., Ltd., and the like.

To the best of the present inventor's knowledge, the conductive composition containing conductive particles that satisfy (a) and (b) described above in the present embodiment has good compatibility with a screen mesh subjected to a roughening treatment and/or liquid-repelling treatment as described above. Although the details are unclear, for example, some characteristics, such as the fluidity, of the conductive composition including conductive particles having a specific particle size distribution may potentially match screen meshes subjected to a roughening treatment and/or liquid-repelling treatment.

From the viewpoint of obtaining sufficient conductivity when made into a conductive film and the viewpoint of ease of coating, the thickness (dry thickness when the conductive composition includes a solvent) of the coating layer 3 is preferably 5 to 100 μm and more preferably 10 to 50 μm.

In particular, when the conductive composition includes a solvent, it is preferable to perform a heat treatment to dry the solvent. The conditions of the heat treatment are not particularly limited as long as the solvent is sufficiently dried, but from the viewpoint of sufficient drying of the solvent and suppression of deterioration of the conductive particles due to excessive heating, the heat treatment temperature is preferably 50 to 150° C. and more preferably 80 to 120° C. The heat treatment time is preferably 1 to 60 minutes and more preferably 3 to 30 minutes.

Specifically, it is possible to perform the heat treatment for drying the solvent by blowing hot air on the coating layer 3. Naturally, the heat treatment may be performed by other methods.

### (FIG. 2: Conductive Film Formation Step)

In the conductive film formation step, the coating layer 3 is at least pressed to form a conductive film. FIG. 2 schematically shows a case where a roll press is adopted as the pressing unit.

When a roll press is adopted as the pressing unit, the base material 1 provided with the coating layer 3 is sandwiched between two opposing rolls 10A and 10B in the conductive film formation step. The sandwiched base material 1 is transported from the left to the right in FIG. 2 by the force of the rotation (indicated by the arrows in FIG. 2) of the rolls 10A and 10B or the like.

In the roll press step, a pressure of 10 MPa or more is preferably applied to the base material 1 provided with the coating layer 3. This pressure is more preferably 10 to 5000 MPa, even more preferably 20 to 300 MPa, and particularly preferably 30 to 250 MPa. By applying a pressure of 10 MPa or more, it is possible to further reduce the resistivity of the obtained conductive film. In addition, by applying a pressure of 5000 MPa or less, it is possible to suppress damage to the base material 1 and the coating layer 3. Incidentally, when the base material 1 has sufficient strength, it is possible to further reduce the resistivity of the conductive film by increasing the pressure.

In the conductive film formation step, it is preferable to press the coating layer 3 while heating.

When the coating layer 3 is heated, the heating temperature may be set appropriately according to the heat resistance of the base material 1, the type of conductive particles to be used, and the like. For example, when the base material 1 is formed of a low heat-resistant material such as polyester, polyolefin, or paper, it is preferable to set the heating temperature in the range of, for example, 50 to 200° C., more preferably 70 to 180° C., even more preferably 70 to 150° C., and particularly preferably 80 to 125° C., taking into consideration the heat resistance temperature of the base material to be used, such that the base material does not substantially soften, melt, carbonize, or the like. However, when the heating time is short, heating at a higher temperature (for example, up to approximately 400° C.) may be permitted.

On the other hand, when the base material 1 is formed of a highly heat-resistant material such as polyimide, it is possible to set the heating temperature to 50 to 400° C. That is, when the coating layer 3 is heated, the temperature is preferably appropriately adjusted to 400° C. or lower.

It is also possible to appropriately set the heating time depending on the heat resistance of the base material 1, the type of conductive particles to be used, and the like. The heating time is, for example, 0.01 to 1 second and preferably 0.04 to 0.6 seconds. Incidentally, when a roll press is adopted in the conductive film formation step, the “heating time” refers to the time during which the coating layer 3 is heated while being in contact with the rolls and pressed. As an example, when the contact width between two opposing rotating rolls is 1 mm and the speed at which the base material passes between the two rolls is v, the heating time (equal to the pressing time) is 0.59 seconds when v=0.1 m/min, 0.04 seconds when v=1.5 m/min, 0.06 seconds when v=1.0 m/min, and 0.012 seconds when v=5.0 m/min.

When a roll press is adopted in the conductive film formation step, to carry out the pressing while heating the coating layer 3, it is preferable that at least the roll 10A, which is on the side closer to the coating layer 3, among the two rolls, is heated. As explained above, it is possible to appropriately set the heating temperature of the roll 10A at 400° C. or lower depending on the heat resistance of the base material 1, the type of conductive particles to be used, and the like. In addition, it is possible to adjust the heating time by changing the rotation speed (that is, the transport speed) of the roll 10A and the roll 10B. The transport speed may be appropriately adjusted between 0.1 and 10 m/min, for example, while taking into consideration the securing of sufficient heating and pressing time, mass productivity, and the like.

In addition, to achieve uniform heating and shorten the heating time, not only the roll 10A but also the roll 10B may be heated.

On the other hand, as long as it is possible to obtain a conductive film having a sufficiently low resistivity, the roll 10A may not be heated and the roll 10B also may not be heated.

In other words, as long as it is possible to obtain a conductive film having a sufficiently low resistivity, the coating layer 3 does not need to be heated in the conductive film formation step. Specifically, when the conductive film formation step includes a roll press step, the roll 10A may not be heated and the roll 10B also may not be heated. In particular, when particles mainly composed of silver are used as the conductive particles, it is possible to easily obtain a conductive film having a sufficiently low resistivity by pressing alone.

Although not shown in FIG. 2, in the roll press step, for example, the rolls 10A and 10B may be rotated while a resin film is sandwiched between the coating layer 3 and the roll 10A. By interposing a resin film between the coating layer 3 and the roll 10A, it is possible to suppress the coating layer 3 from peeling off and attaching to the roll 10A. In addition, by interposing a resin film between the coating layer 3 and the roll 10A, the pressure applied to the coating layer 3 is appropriately dispersed, which tends to make it easier to obtain a conductive film with a more uniform and consistent performance.

The material of the resin film sandwiched between the coating layer 3 and the roll 10A is not particularly limited. In terms of heat resistance and durability, it is possible to preferably use a polyimide film or the like.

To be clear, the roll press step has been explained above as a specific method for the conductive film formation step, but as long as it is possible to apply sufficient pressure (and heat in some cases) to the coating layer 3, the conductive film formation step may be performed by a method other than roll press. However, considering ease of mass production, the conductive film formation step preferably includes a roll press step.

To be clear, an explanation will be given below of steps other than the roll press step that are applicable to the conductive film formation step.

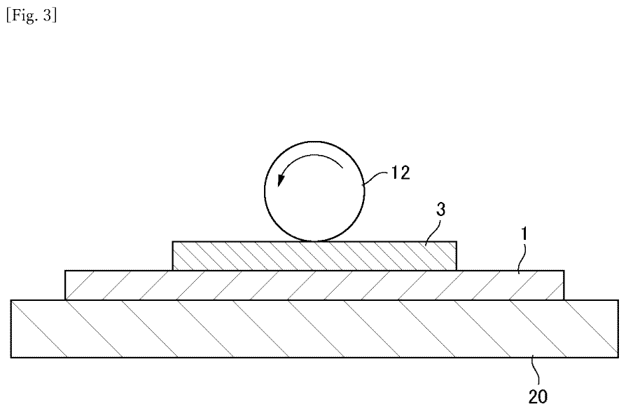

As shown in FIG. 3, the conductive film formation step may include a step of placing the base material 1 provided with the coating layer 3 on a flat surface 20A of a table 20 having a flat surface and at least pressing the coating layer 3 from above using a roll 12. As long as it is possible to apply appropriate pressure, the table 20 having a flat surface may be a flat plate instead of a table. The main point is that the base material 1 is placed on a flat surface and it is possible to carry out the pressing appropriately using the roll 12.

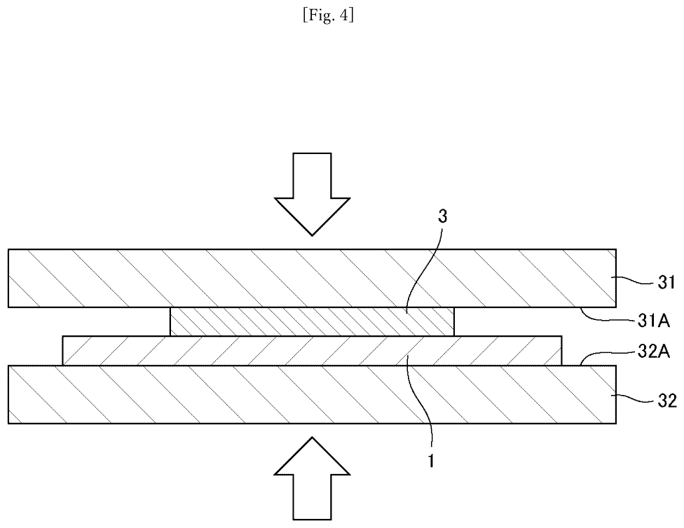

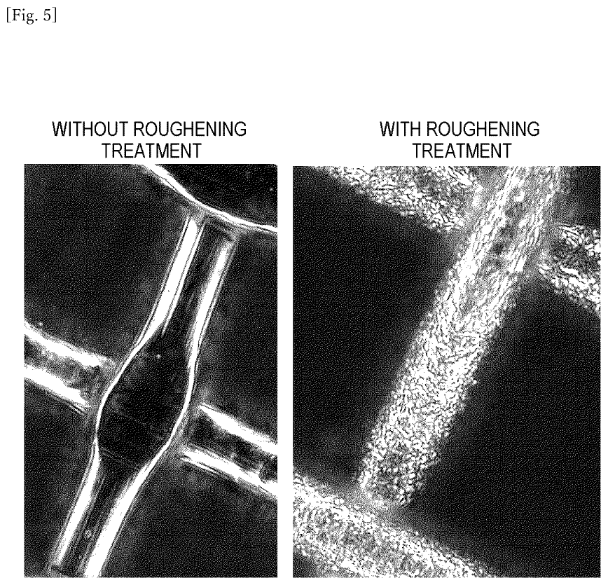

As shown in FIG. 4, the conductive film formation step may include a step of sandwiching the base material 1 provided with the coating layer 3 between a first flat surface 31A of a first pressing member 31 having the first flat surface 31A and a second flat surface 32A of a second pressing member 32 having the second flat surface 32A. An example of a device preferably used for carrying out such a step is the pressing device “CYPF-400” manufactured by Shintokogio, Ltd., or the like.

### <Method for Producing Electronic Device>

It is possible to produce an electronic device using the conductive base material obtained through the above coating step and conductive film formation step. For example, by appropriately designing the “pattern” of the coating in the coating step, it is possible to produce a base material provided with a conductive film (circuit pattern) able to function as a circuit, as well as to produce an electronic device by combining this base material with other electronic elements.

Here, a description will be given of some examples of “electronic devices”, but the electronic devices including the conductive base material obtained by the method for producing a conductive base material of the present embodiment are naturally not limited only thereto.
Sensor: For example, it is possible to apply the conductive base material obtained by the method for producing a conductive base material of the present embodiment in a conductive member/circuit in a sensor such as a pressure sensor or a vital sensor.
Solar cell: For example, it is possible to apply the conductive base material obtained by the method for producing a conductive base material of the present embodiment in the current collector wiring of a solar cell.
Membrane switch: A membrane switch is a thin sheet-like switch in which a circuit and contacts are printed on a film and then laminated. It is possible to apply the method for producing a conductive base material of the present embodiment to form the circuit and contacts.
Touch sensor or touch panel: For example, it is possible to apply the method for producing a conductive base material of the present embodiment to form the lead-out wiring in a touch sensor or a touch panel. In addition, it is also conceivable to apply the method for producing a conductive base material of the present embodiment to form transparent electrodes in a touch sensor or a touch panel.
Flexible base material: In the related art, a circuit is formed by first coating the entire surface of a flexible film with a metal film and then removing unnecessary parts of the metal film using a chemical agent. Instead of such methods of the related art, it is conceivable to form a circuit by the method for producing a conductive base material of the present embodiment.

In particular, in electronic devices of the related art in which circuits are formed using conductive paste, it is possible to expect that using the method for producing a conductive base material of the present embodiment for forming a circuit will reduce the resistivity of the circuit and improve the performance of the electronic device.

Examples of particularly preferable electronic devices include an RF tag. That is, the method for producing a conductive base material of the present embodiment is preferably used to produce a conductive circuit such as an antenna part in an RF tag.

For the specific structure of an RF tag, for example, it is possible to refer to Japanese Unexamined Patent Application, First Publication No. 2003-332714, Japanese Unexamined Patent Application, First Publication No. 2020-46834, and the like.

### <Method for Producing Electromagnetic Shield Film>

As an application other than electronic devices, it is conceivable to produce an electromagnetic shield film by the method for producing a conductive base material of the present embodiment. Specifically, in the coating step, it is possible to produce an electromagnetic shield film by setting the pattern when coating the conductive composition to be a pattern specific to an electromagnetic shield film (a mesh pattern or the like).

### <Method for Producing Sheet-Like Heating Element>

As yet another application, it is conceivable to produce a sheet-like heating element using the method for producing a conductive base material of the present embodiment. A sheet-like heating element generates heat by passing electric current through electrical wiring provided on a base material. Specific examples of sheet-like heating elements include sheet-like heating elements for preventing fogging and protection against cold, for the rear glass of a passenger vehicle or the like.

### <Conductive Composition>

Above, the embodiments of the present invention were explained with a focus on the “methods” of the method for producing a conductive base material and the method for producing an electronic device. Apart from this, it is also possible to regard the embodiments of the present invention as conductive compositions.

That is, the following conductive composition is preferably used to form a conductive film having a low resistivity.

“A conductive composition containing conductive particles, which is used for applications in which a coating layer is formed by coating the conductive composition on a base material and the coating layer is at least pressed to form a conductive film, in which the conductive particles satisfy the following conditions.

### (Conditions)

In a volume-based cumulative particle size distribution curve obtained by particle size measurement of the conductive particles using a laser diffraction-scattering method, when D₅₀ is the particle size at which a cumulative frequency reaches 50%, D₁₀ is the particle size at which the cumulative frequency reaches 10%, and Doo is the particle size at which the cumulative frequency reaches 90%, (a) and (b) described below are satisfied.
(a) D₅₀ is 0.6 to 50 μm.
(b) (D₉₀−D₅₀)/D₅₀ is 0.55 to 3.0.”

Specific forms of the composition were explained in the section <Method for Producing Conductive Base Material>. Therefore, the explanation will not be repeated.

Above, a description was given of the embodiments of the present invention, but these are merely examples of the present invention and it is possible to adopt various other configurations. In addition, the present invention is not limited to the above-described embodiments and includes modifications, improvements, and the like within a range in which it is possible to achieve the purpose of the present invention.

### EXAMPLES

A detailed explanation will be given of the embodiments of the present invention based on Examples and a Comparative Example. To be clear, the present invention is not limited to the Examples.

In the following, exponential notation may be indicated by the symbol “E”. For example, 1.3. E-06 means 1.3×10⁻⁶.

### Examples and Comparative Example

### (Preparation of Conductive Particles)

Conductive particles having the particle size distribution shown in Table 1 were prepared. In Table 1, the units of D₅₀/D₁₀, D₉₀, and D₉₅ are μm.

These conductive particles were purchased from Dowa Electronics Materials Co., Ltd., or Fukuda Metal Foil and Powder Co., Ltd. For example, “Copper 4” in Table 1 is conductive particles available from Fukuda Metal Foil and Powder Co., Ltd., under the product number “EFC-09LML”.

TABLE 1

| Conductive | | | | | (D₉₀ − | (D₅₀ − |
|---|---|---|---|---|---|---|
| particles | D₅₀ | D₁₀ | D₉₀ | D₉₅ | D₅₀)/D₅₀ | D₁₀)/D₅₀ |
| Copper 1 | 10.3 | 4.6 | 20 | 25 | 0.94 | 0.55 |
| Copper 2 | 4.5 | 2.4 | 7.4 | 8 | 0.64 | 0.47 |
| Copper 3 | 6.6 | 3.2 | 14.1 | 18 | 1.14 | 0.52 |
| Copper 4 | 1.4 | 0.6 | 2.2 | 2.9 | 0.57 | 0.57 |
| Silver 1 | 6.1 | 2.0 | 16.0 | 19.1 | 1.62 | 0.67 |
| Silver 2 | 0.8 | 0.3 | 1.5 | 1.8 | 0.88 | 0.63 |
| Comparative | 0.4 | 0.3 | 0.6 | 0.6 | 0.50 | 0.25 |
| copper | | | | | | |

In Table 1, the values related to particle size distribution such as D₅₀ are based on information provided by the supplier.

### (Preparation of Conductive Composition)

77 parts by mass of the above-described conductive particles (one of copper 1 to copper 4, silver 1, silver 2, and comparative copper) and 23 parts by mass of organic solvent were stirred using a planetary stirrer. As a result, a uniform paste-like conductive composition was obtained.

### (Coating Step and Conductive Film Formation Step)

The coating step and conductive film formation step were performed using the following procedure to produce a conductive base material provided with a conductive film.
(1) A coating film (solid film) with a size of 15 mm×5 mm was formed on the base material using the conductive composition. Specifically, first, 3 M Scotch tape was stuck to the base material to create a “cut-out area” with a size of 15 mm×5 mm. Then, a squeegee was used to squeeze the conductive composition on the cut-out area, filling the cut-out area with the conductive composition. The Scotch tape was then removed. The thickness of the coating film at this time was approximately 40 μm.

A polyimide film was used as the base material.
(2) The base material provided with the coating film was placed in a hot air circulating atmospheric oven and heated at 100° C. for 15 minutes. This allowed the solvent to dry.
(3) The coating film from which the solvent had dried was roll pressed together with the base material using a load-adjustable roll press machine (manufactured by Tester Sangyo Co., Ltd., the general structure of which is schematically shown in FIG. 2) under the following conditions:
Temperature of roll 10A: heated to 200° C.
Pressure: 121 MPa
Transport speed: 0.1 m/min

Incidentally, the pressure described above was calculated using the following calculation.
Based on a roll width of 165 mm and a contact width between rolls of 1 mm, the area to which pressure was applied was 165 mm².
The pressing was 20 kN.
Since a force of 20 kN was applied to a region of 165 mm², the pressure was calculated as 121 MPa by calculating 20 kN/165 mm².

### (Measurement of Resistivity)

The resistance value of the conductive film obtained above was measured using a four-terminal resistance meter and the film thickness was measured using a film thickness gauge. The resistivity was calculated from the measured resistance value and film thickness.

The results are shown in Table 2.

TABLE 2

| | Conductive | Resistivity |
|---|---|---|
| | particles | (Ω · cm) |
| Example | Copper 1 | 7.2.E−06 |
| | Copper 2 | 5.8.E−06 |
| | Copper 3 | 7.2.E−06 |
| | Copper 4 | 1.6.E−05 |
| | Silver 1 | 2.8.E−06 |
| | Silver 2 | 3.5.E−06 |
| Comparative | Comparative | 2.3.E−04 |
| Example | copper | |

From Table 1 and Table 2, by using a conductive composition including conductive particles in which (a) D₅₀ was 0.6 to 50 μm and (b) (D₉₀−D₅₀)/D₅₀ was 0.55 to 3.0, it was possible to produce a conductive base material provided with a conductive film having a low resistivity. In addition, it was possible to produce such a conductive base material by a relatively simple process of roll pressing a base material provided with a coating layer while heating.

Incidentally, it is possible to interpret the reason for the poor results of the Comparative Example as being because the particle size of the comparative copper was excessively small, resulting in a larger number of particle boundaries between conductive particles per unit volume than in the Examples (the presence of particle boundaries may cause resistance to increase).

### (Coating Step and Conductive Film Formation Step: Change in Base Material and Heating Temperature)

A conductive base material was produced in the same manner as described above (coating step and conductive film formation step), except that the base material was changed from a polyimide film to a low heat-resistance PET film and the temperature of the roll 10A was changed to 100° C. instead of 200° C. The conductive composition used was a uniform paste formed by stirring 77 parts by mass of conductive particles and 23 parts by mass of an organic solvent shown in the table below using a planetary stirrer.

The resistivity of the obtained conductive base material was calculated in the same manner as described above (measurement of resistivity). The results are shown in Table 3.

TABLE 3

| | Conductive | Resistivity |
|---|---|---|
| | particles | (Ω · cm) |
| Example | Copper 1 | 6.8.E−05 |
| | Copper 4 | 6.1.E−05 |
| | Silver 1 | 4.3.E−06 |

As shown in Table 3, even when the heating temperature in the roll press was a relatively low temperature of 100° C., it was possible to obtain a conductive film having a resistivity value of the order of approximately 10⁻⁵ to 10⁻⁶.

In the Comparative Example in Table 2, even when the heating temperature in the roll press was 200° C., considering that the resistivity value was only on the order of approximately 10⁻⁴, the fact that “it was possible to obtain a conductive film having a resistivity value on the order of approximately 10⁻⁵ to 10⁻⁶” with a heating temperature at a relatively low temperature of 100° C. in the roll press shows the usefulness of the method for producing a conductive base material of the present embodiment.

Incidentally, in the above-described evaluation, no deformation or deterioration due to heat was found in the PET film of the base material.

### Additional Examples

### (Improvement of Adhesion Using Binder)

An additional experiment was performed to verify the effect of improving the adhesion of the conductive film to the base material using a binder.

Specifically, first, each of the components shown in Table 4 below (units of values are “parts by mass”) was uniformly stirred using a planetary stirrer to prepare a conductive composition. As the binder, polyvinylpyrrolidone manufactured by Nippon Shokubai Co., Ltd., was used.

Using the prepared conductive composition, a conductive film was provided in the same manner as described above (coating step and conductive film formation step) and the resistivity was calculated in the same manner as described above (measurement of resistivity).

In addition, a commercially available cellophane tape (registered trademark) manufactured by Nichiban Co., Ltd., was stuck to the conductive film and the cellophane tape was then quickly peeled off in a direction orthogonal to the base material surface, at which time whether or not the conductive film peeled off was evaluated. When the conductive film did not peel off, the evaluation was “good”, and when the conductive film peeled off, the evaluation was “bad”. The compositions of the conductive compositions and the evaluation results are shown in Table 4.

TABLE 4

| | Composition of Conductive | | | | |
|---|---|---|---|---|---|
| | Composition (parts by mass) | | | | |
| | Conductive | | | | |
| | particles: | Polyvinyl- | | Resistivity | |
| | Copper 2 | pyrrolidone | Solvent | (Ω · cm) | Adhesion |
| Additional | 75 | 3 | 22 | 2.0.E−05 | Good |
| Example 1 | | | | | |
| Additional | 75 | 4.5 | 20.5 | 9.5.E−05 | Good |
| Example 2 | | | | | |
| Additional | 75 | 6 | 19 | 1.4.E−04 | Good |
| Example 3 | | | | | |
| Additional | 75 | 0 | 25 | 5.9.E−06 | Bad |
| Example 4 | | | | | |

As shown in Table 4, by using a relatively small amount of binder, it was possible to improve the adhesion of the conductive film to the base material while obtaining a conductive film having a low resistivity.

(In particular, check the resistivity values of Additional

Example 3, which has a relatively large binder amount, and Additional Examples 1 and 2, which have relatively small binder amounts.)

### Example of Change in Pressing Method

A conductive film was formed in the same manner as in the Examples, except that step (3) in the (coating step and conductive film formation step) of the above-described <Examples and Comparative Example> was performed using an apparatus that combined a “flat surface and a roll” as shown in FIG. 3. At this time, the temperature was room temperature and the pressing was approximately the same as in the Examples, 121 MPa. In addition, the conductive composition “Silver 1” in Table 2 was used as the conductive composition.

In addition, the conductive film was formed in the same manner as in the Examples, except that step (3) in the (coating step and conductive film formation step) of the above-described <Examples and Comparative Example> was performed using an apparatus that had a “pair of pressing members having flat surfaces” as shown in FIG. 4. At this time, the temperature was room temperature and the pressing was approximately the same as in the Examples, 121 MPa. In addition, the conductive composition “Silver 1” in Table 2 was used as the conductive composition.

In these two Additional Examples, a conductive film having a resistivity value of the order of approximately 10⁻⁵ Ω·cm was also obtained.

### Example of Change in Pressing Force

A conductive film was formed in the same manner as in the Examples using “copper 2” in Table 2 above, except that the force of the pressing was changed from 121 MPa to 242 MPa. The resistivity of the obtained conductive film was 5.8×10⁻⁶.

In addition, a conductive film was formed in the same manner as in the Example using “copper 1” in Table 3 above, except that the force of the pressing was changed from 121 MPa to 242 MPa. The resistivity of the obtained conductive film was 2.2 ×10⁻⁵.

As described above, it was possible to form a conductive film having a low resistivity even when the pressing force was changed.

### Example Adopting Screen-Printing Method in Coating Step

In the above-described Example, a coating film was provided by squeezing the conductive composition into the “cut-out area” on the base material using a squeegee.

Separately, an example will be described in which the screen-printing method was adopted in the coating step.

First, a description will be given of the various conditions for screen printing.
Screen-Printing Machine
LABTOP 38 manufactured by Micro-Tech Co., Ltd.
Screen Mesh 1

Mesh material: SUS (stainless steel), 325 mesh, wire diameter: 16 μm, emulsion thickness: 28 μm, bias: 22.5°

The screen mesh 1 was subjected to a roughening treatment and a liquid-repelling treatment. For the specific form of the roughening treatment, refer to the image of “with a roughening treatment” in FIG. 5 (FIG. 5 is an enlarged view of a part of the screen mesh). In addition, according to the supplier of the screen mesh, the liquid-repelling treatment was performed by coating (or the like) the surface of the screen mesh with a substance that repels organic solvents such that the contact angle when a mixed solvent of toluene: butanol=9:1 was added dropwise thereto was approximately 60°.

### Screen Mesh 2

The same as the screen mesh 1, except that no roughening treatment or liquid-repelling treatment was carried out.

### Squeegee

Urethane squeegee, hardness 80°

### Conductive Composition

A conductive composition including the copper 2 in Table 1 and adjusted to a viscosity of 70 Pas was used. The viscosity was measured using an E-type viscometer manufactured by Toki Sangyo Co., Ltd., with a jig of 3°×R9.7, a rotation speed of 10 rpm, and a condition of 25° C.

### Printing Conditions

Printing was carried out with a printing pressure of 0.18 MPa, a back pressure of 0.12 MPa, a speed of 50 mm/see, and a clearance of 2.0 mm.

A conductive base material provided with a conductive film was produced in the same manner as described above (coating step and conductive film formation step), except that the coating step was performed by a screen-printing method under the above-described conditions using the screen mesh 1. That is, (1) in the above-described (coating step and conductive film formation step) was performed by the screen-printing method using the screen mesh 1, but (2) and subsequent steps were performed by the same procedure to produce a conductive base material provided with a conductive film. This Example is referred to as “Screen-Printing Example 1”.

In addition, a conductive base material provided with a conductive film was produced in the same manner as described above (coating step and conductive film formation step) except that the coating step was performed by the screen-printing method under the above conditions using the screen mesh 2. That is, (1) in the above-described (coating step and conductive film formation step) was performed by the screen-printing method using the screen mesh 2, but (2) and subsequent steps were performed by the same procedure to produce a conductive base material provided with a conductive film. This Example is referred to as “Screen-Printing Example 2”.

In both Screen-Printing Examples 1 and 2, the resistivity of the obtained conductive film was at approximately the same level as the Examples in Table 2.

To understand the difference in performance due to the difference in the screen mesh used in screen printing, the following evaluations were also performed.

### Evaluation of Continuous Printability

Screen printing was performed continuously 10 times. The pattern obtained by the tenth printing was observed under a microscope.

Some bleeding was observed in Screen-Printing Example 2. In contrast, no bleeding was observed in Screen-Printing Example 1. This is speculated to be because, in Screen-Printing Example 1, the conductive composition was prevented from spreading to the back side (base material side) of the screen mesh used.

### Evaluation of Surface Roughness of Pattern

The surface roughness (Rz) of the pattern surface after heating for 15 minutes at 100° C. in a hot air circulating atmospheric oven after screen printing was measured using a confocal laser microscope.

In Screen-Printing Example 1, Rz was less than 30 μm, but in Screen-Printing Example 2, Rz was 30 μm or more.

The surface roughness of the pattern is often not a particular problem depending on the application of the conductive base material, but when the pattern is used as an antenna, it is preferable that the surface roughness is small due to the so-called skin effect. It is considered that using an appropriate screen mesh makes it possible to form a coating layer with a smaller surface roughness and thus to form a conductive film with a smaller surface roughness. It is considered that it is possible to suitably use a conductive base material provided with such a conductive film as an antenna.

This application claims priority based on Japanese Patent Application No. 2022-148049 filed on Sep. 16, 2022, the entire disclosure of which is incorporated herein by reference.

### REFERENCE SIGNS LIST

1 base material
3 coating layer
10A roll
10B roll
12 roll
20 table having a flat surface
20A flat surface
31 first pressing member
31A first flat surface
32 second pressing member
32A second flat surface

1. A method for producing a conductive base material, the method comprising:
a coating step of coating a conductive composition that contains conductive particles on a base material to provide a coating layer; and
a conductive film formation step of forming a conductive film by at least pressing the coating layer,
wherein, in a volume-based cumulative particle size distribution curve obtained by particle size measurement of the conductive particles using a laser diffraction-scattering method, in a case where D₅₀ is a particle size at which a cumulative frequency reaches 50%, D₁₀ is a particle size at which the cumulative frequency reaches 10%, and D₉₀ is a particle size at which the cumulative frequency reaches 90%, (a) and (b) are satisfied,
(a) D₅₀ is 0.6 to 50 μm,
(b) (D₉₀−D₅₀)/D₅₀ is 0.55 to 3.0.

2. The method for producing a conductive base material according to claim 1,
wherein the base material is flexible.

3. The method for producing a conductive base material according to claim 1,
wherein, in the conductive film formation step, the coating layer is pressed while being heated.

4. The method for producing a conductive base material according to claim 1,
wherein (c) is also satisfied,
(c) (D₅₀−D₁₀)/D₅₀ is 0.4 to 0.8.

5. The method for producing a conductive base material according to claim 1,
wherein, in the volume-based cumulative particle size distribution curve obtained by the particle size measurement of the conductive particles using the laser diffraction-scattering method, in a case where D₉₅ is a particle size at which the cumulative frequency reaches 95%, D₉₅ is 1.5 to 100 μm.

6. The method for producing a conductive base material according to claim 1,
wherein an amount of binder in all non-volatile components of the conductive composition is 5% by mass or less.

7. The method for producing a conductive base material according to claim 1,
wherein the base material is at least one selected from the group consisting of polyester, polyolefin, polyimide, and paper.

8. The method for producing a conductive base material according to claim 1,
wherein the conductive film formation step includes a roll press step of transporting the base material provided with the coating layer between two opposing rolls.

9. The method for producing a conductive base material according to claim 8,
wherein, in the roll press step, a roll of the two rolls with which the coating layer comes into contact is not heated, or is heated to 400° C. or lower.

10. The method for producing a conductive base material according to claim 8,
wherein, in the roll press step, a pressure of 10 MPa or more is applied to the base material provided with the coating layer.

11. The method for producing a conductive base material according to claim 1,
wherein the conductive film formation step includes a step of placing the base material provided with the coating layer on a flat plate or on a flat surface of a table having the flat surface, and at least pressing the coating layer from above using a roll.

12. The method for producing a conductive base material according to claim 1,
wherein the conductive film formation step includes a step of sandwiching the base material provided with the coating layer between a first flat surface of a first pressing member having the first flat surface and a second flat surface of a second pressing member having the second flat surface.

13. The method for producing a conductive base material according to claim 1,
wherein the conductive film has a pattern structure.

14. A method for producing an electronic device,
wherein the electronic device is produced using the conductive base material obtained by the method for producing a conductive base material according to claim 1.

15. The method for producing an electronic device according to claim 14,
wherein the electronic device is an RF tag.

16. A method for producing an electromagnetic shield film,
wherein the electromagnetic shield film is produced using the conductive base material obtained by the method for producing a conductive base material according to claim 1.

17. A method for producing a sheet-like heating element,
wherein the sheet-like heating element is produced using the conductive base material obtained by the method for producing a conductive base material according to claim 1.

18. A conductive composition containing conductive particles, which is used for applications in which a coating layer is formed by coating the conductive composition on a base material and the coating layer is at least pressed to form a conductive film,
in a volume-based cumulative particle size distribution curve obtained by particle size measurement of the conductive particles using a laser diffraction-scattering method, in a case where D₅₀ is a particle size at which a cumulative frequency reaches 50%, D₁₀ is a particle size at which the cumulative frequency reaches 10%, and D₉₀ is a particle size at which the cumulative frequency reaches 90%, (a) and (b) are satisfied,
(a) D₅₀ is 0.6 to 50 μm,
(b) (D₉₀−D₅₀)/D₅₀ is 0.55 to 3.0.

19. The conductive composition according to claim 18,
wherein the conductive particles also satisfy (c),
(c) (D₅₀−D₁₀)/D₅₀ is 0.4 to 0.8.

20. The conductive composition according to claim 18,
wherein, in the volume-based cumulative particle size distribution curve obtained by the particle size measurement of the conductive particles using the laser diffraction-scattering method, in a case where D₉₅ is a particle size at which the cumulative frequency reaches 95%, D₉₅ is 1.5 to 100 μm.

21. The conductive composition according to claim 18,
wherein an amount of binder in all non-volatile components is 5% by mass or less.
